(19) United States
(12) Patent Application Publication
(10) Pub. No.: US 2023/0383958 A1
(43) Pub. Date: Nov. 30, 2023

(54) SHAWARMA SPIT FOR GRILL OR SMOKER

(71) Applicants: David W. Baker, Lakeside, OR (US); Wang Ping, Wuhan (CN)

(72) Inventors: David W. Baker, Lakeside, OR (US); Wang Ping, Wuhan (CN)

(21) Appl. No.: 17/828,972

(22) Filed: May 31, 2022

(51) Int. Cl. F24C 15/16; F16H 57/02

(52) U.S. Cl. CPC F24C 15/164; F24C 15/168; F16H 57/02

(57) ABSTRACT

A spit secures to a housing of a cooking tool and includes a first rod configured to engage an actuator and a second rod configured to support an item being cooked. A gearbox is configured to secure to the first rod and to the second rod such that rotation of the first rod is transmitted to the second rod with a first axis of rotation of the first rod being substantially perpendicular to a second axis of rotation of the second rod. In some embodiments, a plate is secured to a distal end of the second rod. The first rod engages a motor mounted to the housing. The first and/or second rod may have a non-circular cross section.

### FIELD OF THE INVENTION

This invention relates to accessories for grills or smokers.

### BACKGROUND OF THE INVENTION

A typical grill includes a grill, i.e., array of bars supporting food to be cooked, and a direct heat source such as charcoal briquettes, gas burner, or electric heating element. A smoker may likewise include a grill but typically includes a controlled indirect source of heat. For example, a smoker may burn wood pellets in a combustion box. A temperature-controlled feeder mechanism may supply wood pellets to the combustion box.

A grill or smoker enables the user to prepare meats and other food items outside, which is advantageous due to the large amount of smoke these cooking tools produce. Although very popular for this reason, these cooking tools are limited in the cooking tasks they can perform.

### SUMMARY OF THE INVENTION

In one aspect of the invention, a spit includes a first rod configured to engage an actuator and a second rod configured to support an item being cooked. A gearbox is configured to secure to the first rod to and to the second rod such that rotation of the first rod is transmitted to the second rod with a first axis of rotation of the first rod being substantially perpendicular to a second axis of rotation of the second rod. In some embodiments, a plate is secured to a distal end of the second rod. The first and/or second rod may have a non-circular cross section perpendicular to the axis of rotation thereof, such as a rectangular cross section.

In some embodiments, a first sleeve is rotatably positioned within the gearbox and a second sleeve is rotatably positioned within the gearbox. A first bevel gear is secured to the first sleeve and a second bevel gear is secured to the second sleeve and meshed with the first bevel gear. The first rod is selectively secured to the first sleeve and the second rod is selectively secured to the second sleeve. A first thumb screw may be configured to secure the first rod within the first sleeve and a second thumb screw may be configured to secure the second rod within the second sleeve. The first sleeve may define a cavity such that the first rod can slide freely completely through the first sleeve. a mounting flange may be secured to the gearbox and configured to secure the gearbox to a housing of a cooking tool. The cooking tool may be one of a grill and a smoker.

In another aspect of the invention, a cooking tool includes a housing and a motor mounted to an exterior of the housing. A drive rod extends from the motor, through the housing, and into an interior of the housing. A suspending rod is positioned in the interior of the housing. A gearbox couples the drive rod to the suspending rod and transmits rotation of the drive rod to the suspending rod such that an axis of rotation of the suspending rod is substantially perpendicular to an axis of rotation of the drive rod.

A plate may be secured to a distal end of the suspending rod. The suspending rod and/or drive rod may have a non-circular cross section perpendicular to the axis of rotation of the suspending rod. The drive rod and suspending rod may be removably securable to the gearbox and the motor without tools. A lid may be rotatably secured to the housing, an axis of rotation of the lid being substantially parallel to the axis of rotation of the drive rod. The gearbox may be mounted to the interior of the housing. A heat source may be positioned within the interior of the housing.

In another aspect of the invention, a method includes removing a grill from an interior of a housing of a cooking tool and mounting a spit within the interior of the housing. The spit may include a first rod, a second rod perpendicular to the first rod, and a gearbox coupling the first rod to the second rod. An actuator, such as a motor, may be engaged with the first rod. The second rod may extend substantially vertically below the gearbox and have a plate secured thereto for supporting a food item pierced by the second rod.

### BRIEF DESCRIPTION OF THE DRAWINGS

Preferred and alternative examples of the present invention are described in detail below with reference to the following drawings:

FIG. 1 is an isometric view of a cooking tool having a motorized shawarma spit in accordance with an embodiment of the present invention;

FIG. 2 is a front elevation view of the shawarma spit in accordance with an embodiment of the present invention;

FIG. 3 is an isometric view of a bevel gear and sleeve in accordance with an embodiment of the present invention;

FIG. 4 is an isometric view of a gearbox in accordance with an embodiment of the present invention; and

FIG. 5 is an isometric view of the cooking tool having a grill substituted for the shawarma spit in accordance with an embodiment of the present invention.

### DETAILED DESCRIPTION OF THE PREFERRED EMBODIMENT

A shawarma accessory 10 may be understood with respect to a longitudinal direction 12a, vertical direction 12b, and a transverse direction 12c that are all mutually perpendicular to one another. In operation, the longitudinal direction 12a and transverse direction 12c may be substantially parallel to a support surface and the vertical direction 12b may be substantially parallel to the direction of gravity. As used herein “substantially” with reference to an angle may be understood as within five degrees of that angle, e.g., within five degrees of parallel or vertical. The directions 12a, 12b, 12c are defined to facilitate an understanding of the relative location and orientation of features but need not correspond to actual longitudinal, vertical, and transverse directions during use.

The shawarma accessory 10 may include a plate 14. In the illustrated embodiment, the plate 14 is circular with a raised cylindrical rim, both with axes of symmetry substantially parallel to the vertical direction 12a. Other shapes for the plate 14 may be used, such as a rectangular, octagonal, or other polygonal shape with raised rim around the edge thereof. The rim may facilitate the capture of juices from a cooked item 16 positioned above the plate 14 in the vertical direction 12b and possibly supported on the plate 14. The plate 14 is preferably made of a heat tolerant material such as steel, aluminum, or other material. In other embodiments, the plate 14 is made of a tempered glass or other heat tolerant glass or ceramic material.

The plate 14 may be mounted to a suspension rod 18. The axis of symmetry of the plate 14 may be substantially (e.g., within 5 mm) colinear with an axis of rotation of the suspension rod 18. The suspension rod 18 may serve no other function than to the support the plate 14 or may also serve as a skewer passing through the cooked items 16. The suspension rod 18 may have a non-circular cross section in a plane parallel to the longitudinal direction 12a and transverse direction 12c (“the longitudinal-transverse plane”). For example, the suspension rod 18 may have a cross section that is rectangular (e.g., square), elliptical, triangular, star-shaped, or other shape that will tend to resist rotation of the suspension rod 18 relative to the cooked item 16 through which it passes.

The suspension rod 18 may be spun by means of a drive rod 20. The suspension rod 18 may be coupled to the drive rod 20 by means of a gearbox 22. The suspension rod 18, drive rod 20, and gearbox 22 and components within the gearbox 22 may be made of a heat tolerant material such as aluminum, steel, or other metal. In the illustrated embodiment, the axis of rotation of the drive rod 20 is substantially parallel to the longitudinal direction 12a. In some implementations, the drive rod 20 does nothing more than drive the suspension rod 18 through the gearbox 22. In such embodiments, the drive rod 20 may be cylindrical about the axis of rotation thereof. In other embodiments, the drive rod 20 may provide another spit to which a cooked item 24 may be passed. In such embodiments, the drive rod 20 may have a non-circular cross section in a plane parallel to the vertical direction 12b and transverse direction 12c (vertical-transverse plane). For example, any of the possible cross-sectional shapes listed above with respect to the suspension rod 18.

The length of the suspension rod 18 between the gearbox 22 and the plate 14 may be such that space is provided for the food item 16. For example, a length between the gearbox 22 and plate between 10 and 30 cm may be suitable for most applications.

The shawarma spit 10 may be mounted within a housing 26 of a cooking tool such as a grill, smoker, outdoor oven, or other cooking tool. The housing 26 provides a chamber for containing heated air for cooking and may be substantially closed other than vents for combustion gasses and small gaps (e.g., 5 mm or less in width) between panels forming the housing 26. The housing 26 may be made of heat resistant material such as a steel or aluminum.

In the illustrated embodiment, the housing includes left and right sides 28 and a shell 30 spanning between the left and right sides 28 along the longitudinal direction. The gearbox 22 may be substantially centered between the left and right sides 28, such as being intersected by a center plane at a midpoint between the lift and right sides, the center plane being parallel to the vertical direction 12b and transverse direction 12c. Alternatively, the gearbox 22 may be within 10 cm of this center plane.

The shell 30 may be made of one or more pieces of metal such as steel or aluminum. The shell 30 may define an opening 32, which in the illustrated embodiment, spans between the left and right sides 28. In the illustrated embodiment, the plate 14 is positioned below the lower edge of the opening 32 along the vertical direction 12b when in use, though other configurations may also be used. The drive rod 20 may be positioned at or above the lower edge of the opening 32 along the vertical direction 12b in some embodiments.

A lid 34 may hingedly secure to the housing 26, such as near (e.g., within 5 cm of) an upper edge of the opening with an axis of rotation of the lid 34 being substantially parallel to the longitudinal direction 12a. However, in other embodiments, the axis of rotation of the lid 34 is substantially parallel to the vertical direction 12b or other direction that is not parallel to any of the directions 12a, 12b, 12c. When closed, the lid 34 may cover the opening 32 in order to reduce heat loss from within the chamber defined by the housing 26.

In some embodiments, one or both of the sides 28 has a reinforcing plate 36 secured to an inward facing surface thereof. For example, a rim 38 around each side 28 may have the reinforcing plate 36 secured thereto such that the reinforcing plates 36 are offset inwardly from the sides 28 along the longitudinal direction 12a. One side 28 (the right side 28 in the illustrated embodiment) and any reinforcing plate 36 secured thereto may define an opening 40 through which the drive rod 20 may pass. A motor housing 42 may be mounted to the housing 26, such as to an outward facing surface of the side 28 by means of a flange 44. The motor housing 44 may house an electric motor 42a or other driving mechanism, such as a heat (e.g., steam) actuation mechanism, wind-up spring actuated mechanism, or other type of drive mechanism. The motor 42a may be coupled directly to the drive rod 20 or by means of one or more gears. In either case, a driven shaft, gear, or other output may define an opening for slidably receiving the drive rod 20, such as an opening having a non-circular shape matching the non-circular cross-sectional shape of the drive rod 20 while being slightly bigger to permit sliding. A switch 46 may be mounted to the motor housing 42 or elsewhere on the housing 26 and may be actuated by a user in order to turn on the motor 42a within the housing 42. The switch 46 may be connected to a power source such as a battery, electrical cord for connecting to a power grid, vehicle battery, or other power source.

When turned on, the motor 42a may spin the drive rod 20 in a rotational direction 20a about an axis substantially parallel to the longitudinal direction. The rotation of the drive rod 20 is transmitted to the suspension rod 18 through the gearbox 22, resulting in rotation of the suspension rod 18 in a rotational direction 18a, which may be about an axis substantially parallel to the vertical direction 12b.

A heat source 50 may be mounted to or positionable within the housing, such as beneath the plate 14 in the vertical direction 12b and/or adjacent the plate 14 in the transverse direction 12c. The heat source 50 may be embodied as charcoal briquettes, a gas burner, electrical heating element, combustion chamber connected to a pellet feeding system, or other heat source. In the illustrated embodiment, one sidewall 28, e.g., the left sidewall 28 or the sidewall to which the motor housing 42 is not mounted, has an opening 52 defined therein that may be connected to a pellet feeding system supplying pellets to the heat source 50 embodied as wood pellet combustion chamber.

In the illustrated embodiment, the gearbox 22 may be mounted to the housing, such as to the shell 30. For example, an extension flange 54 may extend from the shell 30 to the gearbox 22 and fasten to the gearbox 22 by means of screws, welds, or other fastening means. The extension flange 54 may be fastened to, or monolithically formed with, a mounting flange 56 that is oriented relative to the extension flange 54 such that the mounting flange 56 may secure to the shell 30 while the extension flange is secured o the gearbox 22. The mounting flange 56 may secured to the shell 30 by means of screws, welds, or other fastening means.

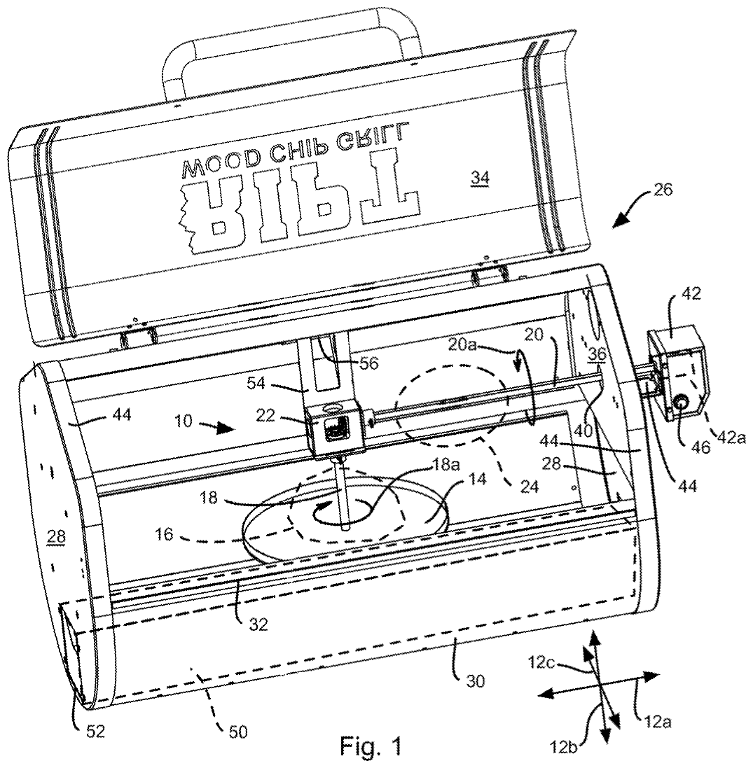

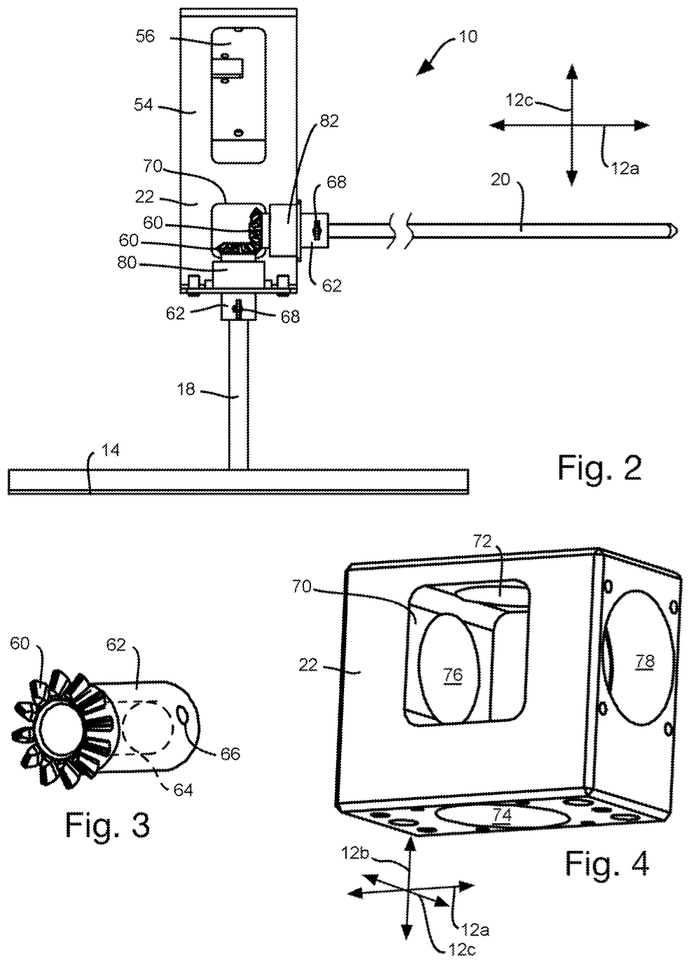

Referring to FIGS. 2-4, while still referring to FIG. 1, the suspension rod 18 and drive rod 20 may be removably secured to the gearbox 20 and the motor 42a within the motor housing 42 in order to facilitate cleaning, permit removal of the shawarma spit 10 when not in use, and to permit cooked items 16, 24 to be positioned on the suspension rod 18 and drive rod 20.

In some embodiments, selective removal and securement of the rods 18, 20 may be facilitated by means of bevel gears 60 secured to sleeves 62 by means of fastener, welds, or monolithic formation therewith. The sleeve 62 may define a cavity 64 sized to receive a portion of a rod 18, 20. In the illustrated example, the cavity 64 is round. However, in other embodiments, the cavity 64 may have a non-circular shape matching the non-circular cross-sectional shape of a rod 18, 20 while being slightly bigger to permit sliding. The cavity 64 may pass completely through the sleeve 62 and bevel gear 60 such that a rod 18, 20 may slide completely through the cavity 64. The sleeve 62 may define an opening 66, such as a threaded opening for receiving a set screw 68 that may be tightened to secure the rod 18, 20 within the cavity 64. In this manner, the rod 18, 20 may be selectively secured to or released from the cavity 64 by tightening or loosening the set screw 68, respectively. In the illustrated embodiment, the set screw 68 is a thumb screw that can be turned without tools. However, other types of threaded fasteners may be used.

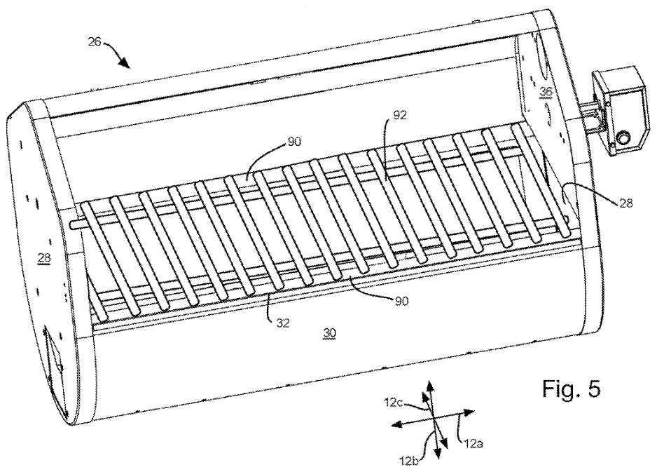

The gearbox 22 may have a generally cuboid shape and define a cavity 70 within which the bevel gears 60 are positioned during use. In the illustrated embodiment, the cavity 70 is open sided, such as in the form of an opening passing completely through the gearbox 22 in the transverse direction 12c (note that directions 12a, 12b, 12c of FIGS. 2 and 4 are mutually perpendicular but may be the same as or different from the directions 12a, 12b, 12c defined in FIG. 1).

The gearbox 22 may define an upper opening 72 and a lower opening 74 that are offset from one another along the vertical direction 12a and extend through the gearbox 22 to the cavity 70. The openings 72, 74 may have axes of symmetry substantially parallel to the vertical direction 12a. The upper opening 72 may be sized to permit a sleeve 62 and bevel gear 60 to pass therethrough whereas the lower opening 74 is sized to permit the sleeve 62 to pass therethrough but not the bevel gear 60. The sleeve 62 may rotated within the opening 74 during use and therefore the opening 74 may be sized to permit such rotation and may include low friction material in order to function as a bearing. The suspension rod 18 may then insert within the cavity 64 of the sleeve 62 and be secured therein by means of the set screw 68.

In a like manner, the gearbox 22 may define a left opening 76 and right opening 78 that each pass through the gearbox 22 to the cavity 70. The examples described herein use the words “left” and “right” with the understanding that these may be reversed. In particular, the motor housing 42 is mounted to the right side 28 in the illustrated embodiment. Where the motor housing 42 is mounted to the left side 28, then the terms “right” and “left” may be exchanged.

The axes of symmetry of the opening 76, 78 may be substantially parallel to the longitudinal direction 12a. The left opening 76 may be sized to permit a sleeve 62 and bevel gear 60 to pass therethrough whereas the right opening 76 is sized to permit the sleeve 62 to pass therethrough but not the bevel gear 60. The sleeve 62 may rotated within the opening 78 during use and therefore the opening 78 may be sized to permit such rotation and may include low friction material in order to function as a bearing. The drive rod 20 may then insert within the cavity 64 of the sleeve 62 and be secured therein by means of the set screw 68.

In some embodiments, a bearing 80 seats within the lower opening 74 and a bearing 82 seats within the right opening 78, the bearings 80, 82 sized to receive the rods 18, 20, respectively and provide a reduced friction interface between the rods 18, 20 and the gearbox 20. In such embodiments, the openings 74, 78 may be sized to receive the bearings 80, 82, respectively, and the bearings 80, 82 define openings sized to receive the sleeves 62, which may be sized to prevent passage of the bevel gears 60 therethrough.

In some embodiments, the manner of assembly of the shawarma spit 10 may be as follows:
1. The gearbox 22 is assembled as shown in FIG. 2 with the bevel gears 60 and sleeves 62 already mounted therein such that the bevel gear 60 of the sleeve 62 within the lower opening 74 meshes with the bevel gear 60 of the sleeve 62 positioned within the right opening 78 (the gearbox 22 may be provided to the user in this state by the manufacturer).
2. The gearbox 22 is mounted to the shell 30 by means of the mounting flange 56.
3. If an item 16 is to be cooked, the item 16 is positioned around the suspension rod 18.
4. The suspension rod 18 is secured within the cavity 64 of the sleeve 62 within the lower opening 74 and the set screws 68 tightened within the opening 66 of the sleeve 62 to secure the suspension rod 18 within the sleeve 62.
5. A first end of the drive rod 20 is slid through the left opening 76, through the cavity 70, and through the cavity 64 in the sleeve 62 positioned within the right opening 78.
6. If an item 24 is to be cooked, the drive rod 20 is passed through the item 24.
7. The drive rod 20 is then slid into the opening 40 and into engagement with the motor 42a. The set screw 68 is then tightened within the opening 66 of the sleeve 62 to secure the drive rod 20 within the sleeve 62.

The plate 14 may either (a) be attached to the suspension rod 18 prior to installation or (b) attached to the suspension rod 18 after the suspension rod 18 is secured to the gearbox 22.

Although the word “shawarma” is used throughout, the shawarma spit 10 may be used to cook gyro meat or any other cut of meat, multiple slices of meat, any vegetable, or any fruit having sufficient structure to be mounted on the drive rod 20 or mounted on the suspension rod 18 with or without support from the plate 14.

Following cooking, cooked items 16, 24 may be cut off the rods 18, 20 or the rods 18, 20 may be removed in a process that is the reverse of the attachment process:
1. The set screw 68 is loosened within the opening 66 of the sleeve 62 to release the drive rod 20 from the sleeve 62. The drive rod 20 is then slid out of the opening 40 and out of engagement with the motor 42a.
2. If an item 24 was cooked and remains on the drive rod 20, the drive rod 20 is drawn out through the item 24.
3. The drive rod 20 is slid through the left and right openings 76 and cavity 70 and through the cavity 64 in the sleeve 62 positioned within the right opening 78. This step may be performed simultaneously with removing the item 24 from the drive rod 20.
4. The set screw 68 is loosened within the opening 66 of the sleeve 62 to release the suspension rod 18 within the sleeve 62.
5. The suspension rod 18 and plate 14 may then be removed and the cooked item 16 removed from the suspension rod 18.
6. If a user desires to completely remove the shawarma spit, the gearbox 22 may be removed from the shell 30 by disconnecting the mounting flange 56 from the shell 30. In some implementation's, the motor housing 42 may remain attached to the housing 26 when the shawarma spit 10 is removed while in others it may be removed when not in use.

Referring to FIG. 5, with the shawarma spit 10 removed, the housing 26 may be used for other purposes. For example, the housing 26 may define two or more rails 90. In the illustrated embodiment, each rail 90 extends along the shell 30 in the longitudinal direction 12a and is offset from the other rail 90 along the transverse direction 12c. The rails 90 may be positioned at or below the lower edge of the opening 32 along the vertical direction 12c. A grill 92 may be placed on the rails 90 such that items on the grill 92 may be cooked using the heat source 50. As known in the art, the grill 92 may include a plurality of rods secured to one another such that there is a gap between adjacent rods of the plurality of rods. A griddle, e.g., solid plate, may likewise be mounted on the rails 90 or set on the grill 92. The grill 92 or griddle may be lifted off the rails 90 and out of the chamber defined by the housing 26 and the shawarma spit installed using the approach described above.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A spit comprising:
a first rod configured to engage an actuator;
a second rod configured to support an item being cooked; and
a gearbox configured to secure to the first rod and the second rod such that rotation of the first rod is transmitted to the second rod with a first axis of rotation of the first rod being substantially perpendicular to a second axis of rotation of the second rod.

2. The spit of claim 1, further comprising a plate secured to a distal end of the second rod.

3. The spit of claim 1, wherein the second rod has a non-circular cross section perpendicular to the first axis of rotation.

4. The spit of claim 3, wherein the second rod has rectangular cross section perpendicular to the first axis of rotation.

5. The spit of claim 3, wherein the first rod has a non-circular cross section perpendicular to the second axis of rotation.

6. The spit of claim 1, further comprising:
a first sleeve rotatably positioned within the gearbox;
a second sleeve rotatably positioned within the gearbox;
a first bevel gear secured to the first sleeve; and
a second bevel gear secured to the second sleeve and meshed with the first bevel gear;
wherein the first rod is selectively secured to the first sleeve and the second rod is selectively secured to the second sleeve.

7. The spit of claim 6, further comprising a first thumb screw configured to secure the first rod within the first sleeve and a second thumb screw configured to secure the second rod within the second sleeve.

8. The spit of claim 6, wherein the first sleeve defines a cavity such that the first rod can slide freely completely through the first sleeve.

9. The spit of claim 1, further comprising a mounting flange secured to the gearbox and configured to secure the gearbox to a housing of a cooking tool.

10. The spit of claim 9, wherein the cooking tool is one of a grill and a smoker.

11. A cooking tool comprising:
a housing;
a motor mounted to an exterior of the housing;
a drive rod extending from the motor, through the housing, and into an interior of the housing;
a suspending rod positioned in the interior of the housing; and
a gearbox coupling the drive rod to the suspending rod and transmitting rotation of the drive rod to the suspending rod such that an axis of rotation of the suspending rod is substantially perpendicular to an axis of rotation of the drive rod.

12. The cooking tool of claim 11, further comprising a plate secured to a distal end of the suspending rod.

13. The cooking tool of claim 11, wherein the suspending rod has a non-circular cross section perpendicular to the axis of rotation of the suspending rod.

14. The cooking tool of claim 11, wherein the drive rod has a non-circular cross section perpendicular to the axis of rotation of the drive rod.

15. The cooking tool of claim 11, wherein the drive rod and suspending rod are removably securable to the gearbox and the motor without tools.

16. The cooking tool of claim 11, further comprising a lid rotatably secured to the housing, an axis of rotation of the lid being substantially parallel to the axis of rotation of the drive rod.

17. The cooking tool of claim 11, wherein the gearbox is mounted to the interior of the housing.

18. The cooking tool of claim 11, further comprising a heat source positioned within the interior of the housing.

19. A method comprising:
removing a grill from an interior of a housing of a cooking tool;
mounting a spit within the interior of the housing, the spit including a first rod, a second rod perpendicular to the first rod, and a gearbox coupling the first rod to the second rod; and
engaging the first rod with an actuator.

20. The method of claim 19, wherein the second rod extends substantially vertically below the gearbox and has a plate secured thereto for supporting a food item pierced by the second rod.
